(19) United States
(12) Patent Application Publication
(10) Pub. No.: US 2017/0344260 A1
(43) Pub. Date: Nov. 30, 2017

(54) ELECTRONIC DEVICE AND OPERATING METHOD THEREOF

(71) Applicant: SK hynix Inc., Gyeonggi-do (KR)

(72) Inventor: Joo Young LEE, Gyeonggi-do (KR)

(21) Appl. No.: 15/249,117

(22) Filed: Aug. 26, 2016

(30) Foreign Application Priority Data
May 25, 2016 (KR) 10-2016-0064140

(51) Int. Cl. G06F 3/06; G06F 1/32; G06F 12/06

(52) U.S. Cl. CPC G06F 3/061; G06F 3/0688; G06F 12/0638; G06F 1/3287; G06F 3/0659; G06F 2212/205

(57) ABSTRACT

An electronic device includes a first memory suitable for storing a plurality of segment codes each associated with at least one operation; a second memory; and a processor suitable for loading a first segment code among the plurality of segment codes from the first memory to the second memory, and performing an operation associated with the first segment code by executing the first segment code loaded into the second memory.

### CROSS-REFERENCES TO RELATED APPLICATION

The present application claims priority under 35 U.S.C. §119(a) to Korean application number 10-2016-0064140, filed on May 25, 2016, which is herein incorporated by reference in its entirety.

### BACKGROUND

### 1. Technical Field

Various embodiments generally relate to an electronic device, and, more particularly, to an electronic device including a memory device.

### 2. Related Art

Data storage devices store data provided by an external device in response to a write request. Data storage devices may also provide stored data to an external device in response to a read request. Examples of external devices that use data storage devices include computers, digital cameras, cellular phones and the like. Data storage devices may be embedded in an external device during manufacturing of the external devices or may be fabricated separately and then connected afterwards to an external device.

### SUMMARY

In an embodiment, an electronic device may include: a first memory suitable for storing a plurality of segment codes each associated with at least one operation; a second memory; and a processor suitable for loading a first segment code among the plurality of segment codes from the first memory to the second memory, and performing an operation associated with the first segment code by executing the first segment code loaded into the second memory.

In an embodiment, a method for operating an electronic device may include: loading at least first segment code among a plurality of segment codes each associated with at least one operation, from a first memory into a second memory; and performing an operation associated with the first segment code by executing the first segment code loaded into the second memory.

### BRIEF DESCRIPTION OF THE DRAWINGS

FIG. 1 is a block diagram illustrating an electronic device in accordance with an embodiment.

FIG. 2 is a flow chart illustrating a method for operating the electronic device of FIG. 1.

FIGS. 3 to 5 are flow charts illustrating methods for loading a code in the electronic device of FIG. 1.

FIGS. 6A to 6C are diagrams illustrating that segment codes are stored in the first memory shown in FIG. 1.

FIG. 7 is a block diagram illustrating a solid state drive (SSD) in accordance with an embodiment.

FIG. 8 is a block diagram illustrating a data processing system in accordance with an embodiment.

### DETAILED DESCRIPTION

Hereinafter, a data storage device and an operating method thereof according to the present invention will be described with reference to the accompanying drawings through exemplary embodiments of the present invention. The present invention may, however, be embodied in different forms and should not be construed as being limited to the embodiments set forth herein. Rather, these embodiments are provided to describe the present invention in detail to the extent that a person skilled in the art to which the invention pertains can enforce the technical concepts of the present invention.

It is to be understood that embodiments of the present invention are not limited to the particulars shown in the drawings, that the drawings are not necessarily to scale, and, in some instances, proportions may have been exaggerated to more clearly depict certain features of the invention. While particular terminology is used, it is to be appreciated that the terminology used is for describing particular embodiments only and is not intended to limit the scope of the present invention.

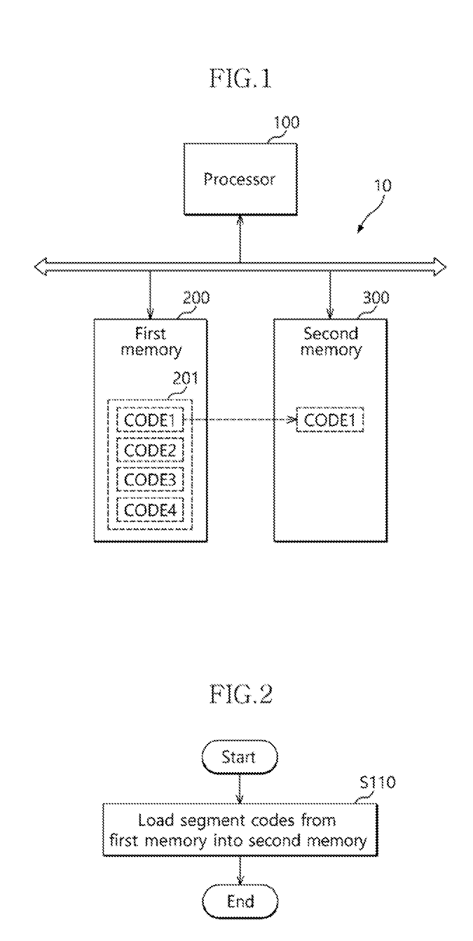

FIG. 1 is a block diagram illustrating an electronic device 10 in accordance with an embodiment.

The electronic device 10 may be a device capable of processing data or a data storage device. The electronic device 10 as the device capable of processing data may include a computer, a laptop, a netbook, a smart phone, a digital television (TV), a digital camera, a navigator, a workstation or a wearable device.

The electronic device 10 as the data storage device may be a Personal Computer Memory Card International Association (PCMCIA) card, a Compact Flash (CF) card, a smart media card, a memory stick, various multimedia cards (for example, MMC, eMMC, RS-MMC, and MMC-Micro), various secure digital cards (for example, SD, Mini-SD, and Micro-SD), a Universal Flash Storage (UFS), a Solid State Drive (SSD) and the like.

The electronic device 10 may include a processor 100, a first memory 200, and a second memory 300.

The processor 100 may control general operations of the electronic device 10. The processor 100 may load a code 201 from the first memory 200 into the second memory 300 through a code loading operation, and may perform internal operations of the electronic device 10 by executing the loaded code 201. The code loading operation may be performed when the electronic device 10 is powered on or wakes up from a sleep mode.

The code 201 may be software that is needed to manage the electronic device 10, and may include a plurality of commands to be executed by the processor 100. The code 201 may be constructed by segment codes CODE1 to CODE4. Each of the segment codes CODE1 to CODE4 may be associated with at least one independent internal operation. Therefore, the processor 100 may perform internal operations associated therewith, by executing the respective segment codes CODE1 to CODE4. While it is illustrated in FIG. 1 that the code 201 is constructed by 4 segment codes CODE1 to CODE4, it is to be noted that, according to the embodiment, the number of segment codes which construct the code 201 is not limited thereto.

The processor 100 may load the respective segment codes CODE1 to CODE4 from the first memory 200 into the second memory 300. That is, the processor 100 may not simultaneously load the segment codes CODE1 to CODE4 into the second memory 300 through one code loading operation, and may divisionally load the segment codes CODE1 to CODE4 through a plurality of code loading operations according to operation states of the electronic device 10. In this regard, since each of the segment codes CODE1 to CODE4 is associated with at least one independent internal operation, the processor 100 may perform associated internal operations by executing the segment codes loaded already, even before the entire code 201 is loaded into the second memory 300. As a result, in the present embodiment, the processor 100 may first load a preferentially necessary segment code, and may load remaining segment codes in parallel with performing the internal operation associated with the first loaded segment code. Accordingly, the code loading time, the booting time and the stabilization time of the electronic device 10 may be shortened, whereby the operational performance of the electronic device 10 may be improved.

In detail, the processor 100 may load the second segment code CODE2 into the second memory 300 in parallel with performing the internal operation associated with the first segment code CODE1 loaded in advance into the second memory 300. For example, the processor 100 may load the second segment code CODE2 from the first memory 200 into the second memory 300 at the same time with performing the internal operation associated with the first segment code CODE1. For example, the processor 100 may control the second segment code CODE2 to be read from a memory region of the first memory 200 to an output buffer (not shown), while performing the internal operation associated with the first segment code CODE1, and may control the second segment code CODE2 to be outputted from the output buffer of the first memory 200 to the second memory 300, when the internal operation associated with the first segment code CODE1 is completed. That is, since a time during which the second segment code CODE2 is read from the memory region of the first memory 200 to the output buffer overlaps with a time for performing the Internal operation, for example, an initialization operation associated with the first segment code CODE1, the electronic device 10 may complete the code loading operation quickly.

According to an embodiment, the processor 100 may determine whether the electronic device 10 enters an idle state. When it is determined that the electronic device 10 enters the idle state, the processor 100 may load the third segment code CODE3 from the first memory 200 into the second memory 300. The third segment code CODE3 may be a segment code which is not necessary to be preferentially loaded, that is, a segment code which does not exert a substantial influence on the operation of the electronic device 10 even though it is not loaded immediately.

The processor 100 may load the segment codes CODE1 to CODE4 according to a predetermined loading sequence for the segment codes CODE1 to CODE4. For example, the predetermined loading sequence may be determined based on the importance of the Internal operations associated with the segment codes CODE1 to CODE4. For example, the processor 100 may initially load a segment code such as, the first segment code CODE1 which is associated with the initialization operation for setting the internal parameters of the electronic device 10.

The processor 100 may load, according to a request from an exterior and regardless of the predetermined loading sequence, a segment code, for example, the fourth segment code CODE4 which is associated with the request from the exterior, from the first memory 200 into the second memory 300. Namely, the fourth segment code CODE4 may be first loaded regardless of the predetermined loading sequence to process the request from the exterior, even though the fourth segment code CODE4 does not have a turn to be loaded earlier than the other segment codes CODE1 to CODE3, according to the predetermined loading sequence. The processor 100 may defer processing of the request from the exterior, until the fourth segment code CODE4 is loaded into the second memory 300. Furthermore, the exterior may be an external device which is connected to the electronic device 10 and a user who uses the electronic device 10 and which controls the electronic device 10.

According to an embodiment, the processor 100 may not load some of the segment codes CODE1 to CODE4 into the second memory 300 depending upon a state when the electronic device 10 is previously powered off. For example, when it is determined that it is not necessary to perform again an internal operation performed before the electronic device 10 is previously powered off, the processor 100 may not load the segment code associated with the corresponding internal operation, into the second memory 300. Consequently, the code loading operation may be completed more quickly.

The first memory 200 may store data according to control of the processor 100. When the electronic device 10 is a data storage device, the first memory 200 may store data received from the exterior, according to control of the processor 100.

The first memory 200 may retain the data previously stored therein, even though power is not supplied to the electronic device 10. For example, the first memory 200 may include a nonvolatile memory device such as a programmable ROM (PROM), an one time PROM (OTPROM), an erasable PROM (EPROM), a flash memory device such as a NAND flash or a NOR flash, an ferroelectric random access memory (FeRAM), a phase change random access memory (PCRAM), a magnetic random access memory (MRAM) and a resistive random access memory (ReRAM).

The first memory 200 may store the segment codes CODE1 to CODE4 due to the nonvolatile characteristic thereof. The segment codes CODE1 to CODE4 may be stored in the first memory 200 when manufacturing the electronic device 10. The segment codes CODE1 to CODE4 may be stored in memory regions which are distinguished from one another, in the first memory 200. Each of the segment codes CODE1 to CODE4 may be stored in a unit memory region corresponding to a unit by which the first memory 200 performs a read operation, that is, a unit which may be read at a time by the first memory 200, according to the size of the corresponding code. Each of the segment codes CODE1 to CODE4 may be stored in the first memory 200 in such a way as to be able to be read through a minimum number of read operations, according to the size of the corresponding code.

According to an embodiment, the first memory 200 may include a plurality of memory devices, and the segment codes CODE1 to CODE4 may be divisionally stored in the plurality of memory devices. In this case, the segment codes CODE1 to CODE4 stored in different memory devices may be loaded in parallel, and accordingly, the code loading operation may be completed more quickly.

The second memory 300 may perform a function as a working memory, a buffer memory or a cache memory of the processor 100. The second memory 300 as a working memory may store the code 201 which is transmitted from the first memory 200 and is executed by the processor 100. The second memory 300 as a buffer memory may buffer the data transmitted between the exterior and the first memory 200. The second memory 300 as a cache memory may temporarily store cache data.

The second memory 300 may not retain data stored therein, in the case where power is not supplied to the electronic device 10 or the electronic device 10 enters a sleep mode. For example, the second memory 300 may include a volatile memory device such as a static random access memory (SRAM) and a dynamic random access memory (DRAM).

FIG. 2 is a flow chart illustrating a method for operating the electronic device 10 of FIG. 1.

At step S110, the processor 100 may load the respective segment codes CODE1 to CODE4 from the first memory 200 into the second memory 300 through a code loading operation. The code loading operation may be performed when the electronic device 10 is powered on or wakes up from a sleep mode. The processor 100 may not simultaneously load the segment codes CODE1 to CODE4 into the second memory 300 through one code loading operation, and may divisionally load the segment codes CODE1 to CODE4 through a plurality of code loading operations according to operation states of the electronic device 10. The processor 100 may perform associated internal operations by executing the segment codes loaded already, even though the entire code 201 is not loaded.

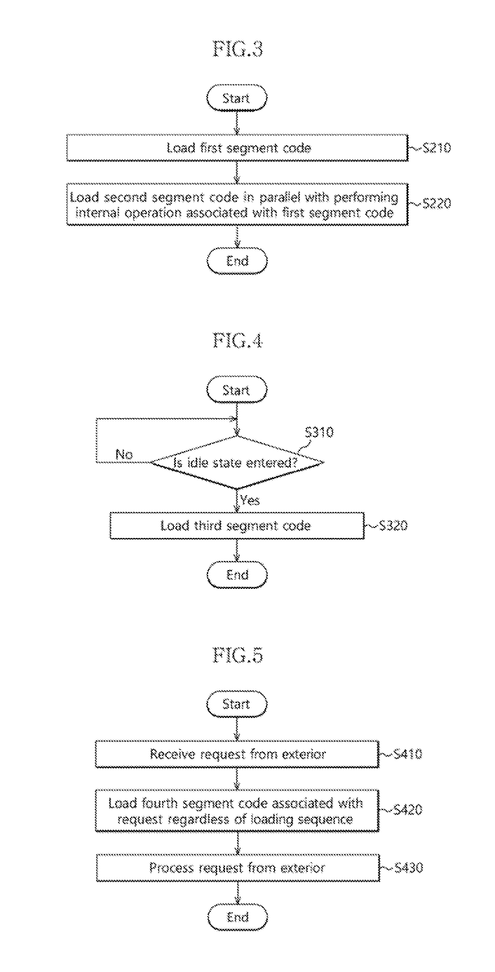

FIGS. 3 to 5 are flow charts illustrating methods for loading a code in the electronic device 10 of FIG. 1. The code loading methods shown in FIGS. 3 to 5 may be embodiments of the step S110 shown in FIG. 2.

Referring to FIG. 3, at step S210, the processor 100 may load the first segment code CODE1 from the first memory 200 into the second memory 300.

At step S220, the processor 100 may load the second segment code CODE2 from the first memory 200 into the second memory 300, in parallel with performing the internal operation associated with the first segment code CODE1 by executing the first segment code CODE1.

Referring to FIG. 4, at step S310, the processor 100 may determine whether the electronic device 10 has entered an idle state. When it is determined that the electronic device 10 has not entered the idle state (S310, No), the process may iterate the step S310. When it is determined that the electronic device 10 has entered the idle state (S310, Yes), the process may proceed to step S320.

At the step S320, the processor 100 may load the third segment code CODE3 from the first memory 200 into the second memory 300. The third segment code CODE3 may be a segment code which is not necessary to be preferentially loaded, that is, a segment code which does not exert a substantial influence on the operation of the electronic device 10 even though it is not loaded immediately.

Referring to FIG. 5, at step S410, the processor 100 may receive a request from the exterior.

At step S420, the processor 100 may load the fourth segment code CODE4 which is associated with the received request, from the first memory 200 into the second memory 300, regardless of the predetermined loading sequence for the segment codes CODE1 to CODE4. The processor 100 may defer processing of the request from the exterior, until the fourth segment code CODE4 is loaded.

At step S430, the processor 100 may perform the Internal operation associated with the fourth segment code CODE4 by executing the fourth segment code CODE4 loaded into the second memory 300, and may thereby process the request from the exterior.

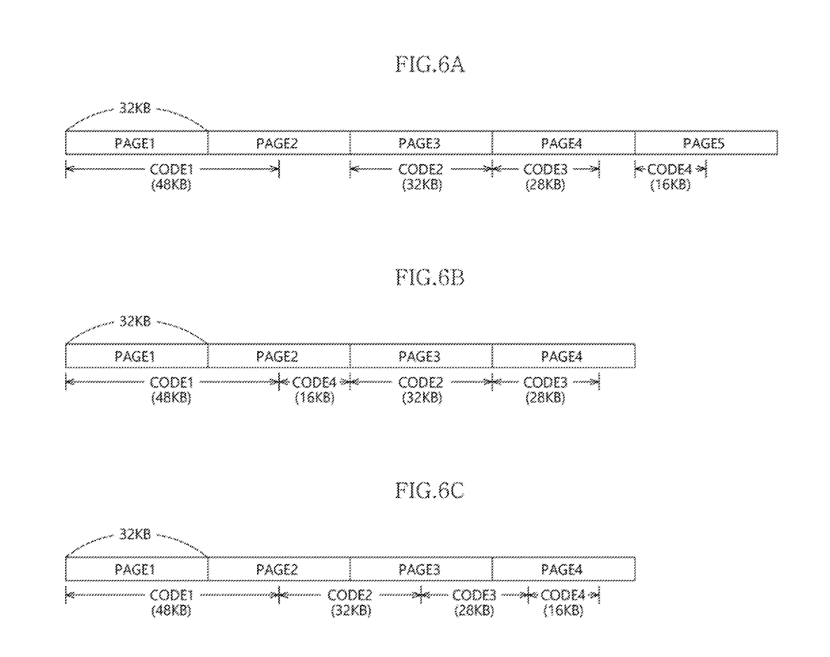

FIGS. 6A to 6C are diagrams illustrating that the segment codes CODE1 to CODE4 are stored in the first memory 200 shown in FIG. 1.

As aforementioned, the processor 100 may load the respective segment codes CODE1 to CODE4 independently of one another. Hence, in order to effectively perform the independent loading, the segment codes CODE1 to CODE4 may be efficiently disposed in the first memory 200 in consideration of the size of a unit memory region corresponding to a unit by which the first memory 200 performs a read operation, that is, a unit which may be read at a time by the first memory 200, and the sizes of the segment codes CODE1 to CODE4. For example, the respective segment codes CODE1 to CODE4 may be stored in unit memory regions which are distinguished from one another, according to the sizes thereof. For example, each of the segment codes CODE1 to CODE4 may be stored in the first memory 200 in such a way as to be able to be read through a minimum number of read operations, according to the size of the corresponding code.

FIGS. 6A and 6B illustrate cases where the segment codes CODE1 to CODE4 are efficiently disposed in the first memory 200 according to the sizes thereof when the unit memory region is 32 Kbytes. Conversely, FIG. 6C illustrates a case where the segment codes CODE1 to CODE4 are inefficiently disposed in the first memory 200 without considering the sizes thereof according to the predetermined loading sequence. In FIG. 6C, because the second segment code CODE2 is stored over pages PAGE2 and PAGE3, in order for the second segment code CODE2 to be loaded into the second memory 300, read operations should be performed for the respective pages PAGE2 and PAGE3. However, in FIGS. 6A and 6B, because the second segment code CODE2 is stored in only one page PAGE3, only a read operation for the page PAGE3 may be performed. In this way, because the respective segment codes CODE1 to CODE4 may be loaded into the second memory 300 through a minimum number of read operations when they are stored as illustrated in FIGS. 6A and 6B, code loading may be completed at a higher speed than when the respective segment codes CODE1 to CODE4 are stored as illustrated in FIG. 6C.

Meanwhile, in the case where the segment codes CODE1 to CODE4 are stored at appropriate positions in consideration of the sizes thereof, space utilization efficiency may be improved. For example, in the case where the first segment code CODE1 is stored over pages PAGE1 and PAGE2 and the fourth segment code CODE4 is stored in the remaining space as shown in FIG. 6B, total 4 pages PAGE1 to PAGE4 may be used to store the segment codes CODE1 to CODE4. Therefore, in this case of FIG. 6B, efficiency may be improved when compared to the case of FIG. 6A in which total 5 pages including PAGE1 to PAGE5 are used.

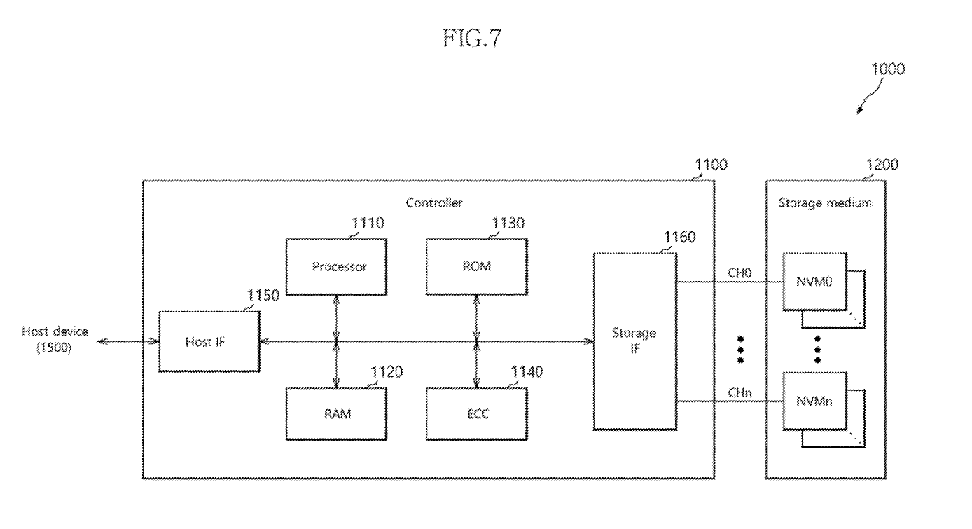

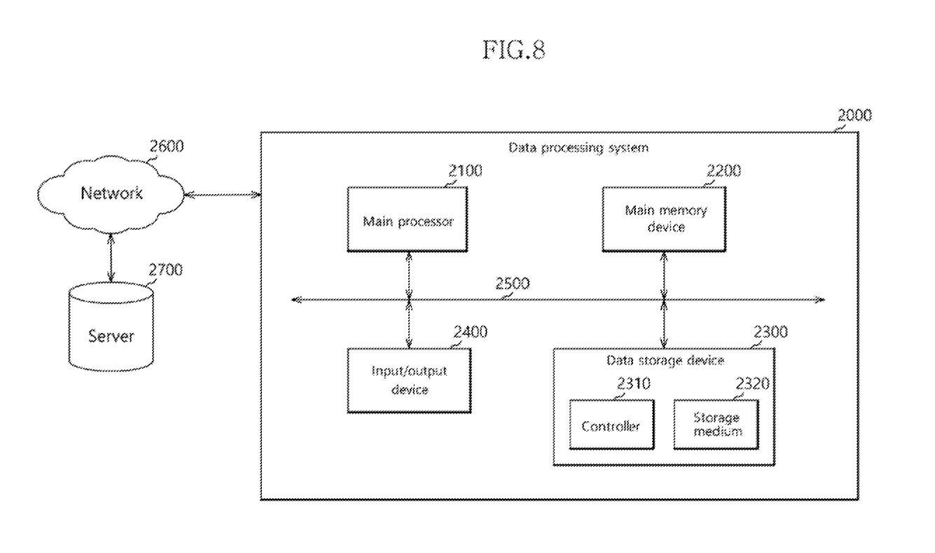

FIG. 7 is a block diagram illustrating a solid state drive (SSD) 1000 in accordance with an embodiment.

Referring to FIG. 7, the SSD 1000 may include a controller 1100 and a storage medium 1200.

The controller 1100 may control data exchange between a host device 1500 and the storage medium 1200. The controller 1100 may include a processor 1110, a random access memory (RAM) 1120, a read only memory (ROM) 1130, an error correction code (ECC) unit 1140, a host interface 1150, and a storage medium interface 1160.

The processor 1110 may control general operations of the controller 1100. The processor 1110 may store data in the storage medium 1200 and read stored data from the storage medium 1200, according to data processing requests from the host device 1500. To efficiently manage the storage medium 1200, the processor 1110 may control internal operations of the SSD 1000 such as a merge operation, a wear leveling operation, and so forth.

Also, the processor 1110 may operate in a manner substantially similar to the processor 1110 shown in FIG. 1. The processor 1110 may not simultaneously load a plurality of segment codes constructing a code into the RAM 1120 through one code loading operation, and may divisionally load the plurality of segment codes through a plurality of code loading operations according to operation states of the SSD 1000. The processor 1110 may first load a preferentially necessary segment code among the plurality of segment codes, and may load remaining segment codes in parallel with performing the internal operation associated with the first loaded segment code.

Like the second memory 300 shown in FIG. 1, the RAM 1120 may store programs and program data to be used by the processor 1110. The RAM 1120 may temporarily store data transmitted from the host interface 1150 before transferring it to the storage medium 1200, and may temporarily store data transmitted from the storage medium 1200 before transferring it to the host device 1500.

Like the first memory 200 shown in FIG. 1, the ROM 1130 may store codes to be loaded by the processor 1110. The codes may include commands to be processed by the processor 1110, for the processor 1110 to control the internal units of the controller 1100.

The ECC unit 1140 may encode data to be stored in the storage medium 1200, and may decode data read from the storage medium 1200. The ECC unit 1140 may detect and correct an error which occurred in data, according to an ECC algorithm.

The host interface 1150 may exchange data processing requests, data, etc. with the host device 1500.

The storage medium interface 1160 may transmit control signals and data to the storage medium 1200. The storage medium interface 1160 may be transmitted with data from the storage medium 1200. The storage medium interface 1160 may be coupled with the storage medium 1200 through a plurality of channels CH0 to CHn.

A storage medium 1200 may include a plurality of nonvolatile memory devices NVM0 to NVMn. Each of the plurality of nonvolatile memory devices NVM0 to NVMn may perform a write operation and a read operation according to control of the controller 1100. Like the first memory 200 shown in FIG. 1, each of the plurality of nonvolatile memory devices NVM0 to NVMn may store the code loaded by the processor 1110.

FIG. 8 is a block diagram illustrating a data processing system 2000 in accordance with an embodiment.

Referring to FIG. 8, the data processing system 2000 may include a main processor 2100, a main memory device 2200, a data storage device 2300, and an input/output device 2400. The internal units of the data processing system 2000 may exchange data, control signals, etc. through a system bus 2500.

The main processor 2100 may control general operations of the data processing system 2000. The main processor 2100 may be a central processing unit such as a microprocessor. The main processor 2100 may execute softwares such as an operation system, an application, a device driver, and so forth, on the main memory device 2200. The main processor 2100 may operate in a manner substantially similar to the processor 100 shown in FIG. 1. The main processor 2100 may not simultaneously load a plurality of segment codes constructing a code into the main memory device 2200 through one code loading operation, and may divisionally load the plurality of segment codes through a plurality of code loading operations according to operation states of the data processing system 2000. The main processor 2100 may first load a preferentially necessary segment code among the plurality of segment codes, and may load remaining segment codes in parallel with performing the internal operation associated with the first loaded segment code.

Like the second memory 300 shown in FIG. 1, the main memory device 2200 may store programs and program data used by the main processor 2100. The main memory device 2200 may temporarily store data transmitted to the data storage device 2300 and the input/output device 2400.

The data storage device 2300 may include a controller 2310 and a storage medium 2320. Like the first memory 200 shown in FIG. 1, the storage medium 2320 may store a code loaded by the main processor 2100.

The input/output device 2400 may include a keyboard, a scanner, a touch screen, a screen monitor, a printer, a mouse, or the like, capable of exchanging data with a user, such as receiving a command for controlling the data processing system 2000 from the user or providing a processed result to the user.

According to an embodiment, the data processing system 2000 may communicate with at least one server 2700 through a network 2600 such as a local area network (LAN), a wide area network (WAN), a wireless network, and so on. The data processing system 2000 may include a network interface (not shown) to access the network 2600.

While various embodiments have been described above, it will be understood to those skilled in the art that the embodiments described are examples only. Accordingly, the data storage device and the operating method thereof described herein should not be limited based on the described embodiments. Many other embodiments and or variations thereof may be envisaged by those skilled in the relevant art without departing from the spirit and or scope of the present invention as defined in the following claims.

What is claimed is:

1. An electronic device comprising:
a first memory suitable for storing a plurality of segment codes each associated with at least one operation;
a second memory; and
a processor suitable for loading a first segment code among the plurality of segment codes from the first memory to the second memory, and performing an operation associated with the first segment code by executing the first segment code loaded into the second memory.

2. The electronic device according to claim 1, wherein the processor loads a second segment code among the plurality of segment codes from the first memory into the second memory in parallel with performing the operation associated with the first segment code.

3. The electronic device according to claim 2, wherein the processor controls the second segment code read from a memory region of the first memory to an output buffer of the first memory while performing the operation associated with the first segment code, and controls the second segment code to be outputted from the output buffer to the second memory when the operation is completed.

4. The electronic device according to claim 1, wherein when it is determined that the electronic device enters an idle state, the processor loads a third segment code among the plurality of segment codes from the first memory into the second memory.

5. The electronic device according to claim 1, wherein the processor loads the plurality of segment codes according to a predetermined loading sequence.

6. The electronic device according to claim 5, wherein the processor loads, according to a request from an exterior and regardless of the predetermined loading sequence, a fourth segment code among the plurality of segment codes which is associated with the request from the exterior, from the first memory into the second memory.

7. The electronic device according to claim 6, wherein the processor defers processing of the request from the exterior, until the fourth segment code is loaded.

8. The electronic device according to claim 1, wherein the processor initially loads a fifth segment code among the plurality of segment codes, which is associated with an initialization operation.

9. The electronic device according to claim 1,
wherein the first memory includes a plurality of unit memory regions, and
wherein the segment codes are stored in the unit memory regions based on sizes of the segment codes and the unit memory regions.

10. The electronic device according to claim 1, wherein the first memory includes a nonvolatile memory, and the second memory includes a volatile memory.

11. A method for operating an electronic device, comprising:
loading at least one first segment code among a plurality of segment codes each associated with at least one operation, from a first memory into a second memory; and
performing an operation associated with the first segment code by executing the first segment code loaded into the second memory.

12. The method according to claim 11, wherein the loading of the at least the first segment code among the plurality of segment codes comprises:
loading a second segment code among the plurality of segment codes from the first memory into the second memory in parallel with performing the operation associated with the first segment code.

13. The method according to claim 12, wherein the loading of the second segment code comprises:
controlling the second segment code read from a memory region of the first memory to an output buffer of the first memory, while performing the operation associated with the first segment code; and
controlling the second segment code to be outputted from the output buffer to the second memory, when the operation is completed.

14. The method according to claim 11, wherein the loading of the at least the first segment code among the plurality of segment codes comprises:
determining whether the electronic device enters an idle state; and
loading a third segment code among the plurality of segment codes from the first memory into the second memory, when it is determined that the electronic device enters the idle state.

15. The method according to claim 11, wherein the loading of the at least the first segment code among the plurality of segment codes comprises:
loading the plurality of segment codes according to a predetermined loading sequence.

16. The method according to claim 15, wherein the loading of the at least the first segment code among the plurality of segment codes comprises:
loading, according to a request from an exterior and regardless of the predetermined loading sequence, a fourth segment code among the plurality of segment codes which is associated with the request from the exterior, from the first memory into the second memory.

17. The method according to claim 16, wherein the loading of the at least the first segment code among the plurality of segment codes further comprises:
deferring processing of the request from the exterior, until the fourth segment code is loaded.

18. The method according to claim 11, wherein the loading of the at least the first segment code among the plurality of segment codes comprises:
loading initially a fifth segment code among the plurality of segment codes which is associated with an initialization operation.

19. The method according to claim 11,
wherein the first memory includes a plurality of unit memory regions, and
wherein the segment codes are stored in the unit memory regions based on sizes of the segment codes and the unit memory regions.

20. The method according to claim 11, wherein the first memory includes a nonvolatile memory, and the second memory includes a volatile memory.
